(19) United States
(12) Patent Application Publication
(10) Pub. No.: US 2020/0203776 A1
(43) Pub. Date: Jun. 25, 2020

(54) WOUND BATTERY AND MANUFACTURING METHOD OF WOUND BATTERY

(71) Applicant: Honda Motor Co.,Ltd., Tokyo (JP)

(72) Inventors: Wataru SHIMIZU, Saitama (JP); Masahiro OHTA, Saitama (JP); Toru SUKIGARA, Saitama (JP)

(73) Assignee: Honda Motor Co.,Ltd., Tokyo (JP)

(21) Appl. No.: 16/689,091

(22) Filed: Nov. 20, 2019

(30) Foreign Application Priority Data
Dec. 20, 2018 (JP) 2018-238120

(51) Int. Cl. H01M 10/0587; H01M 10/0525

(52) U.S. Cl. CPC H01M 10/0587; H01M 10/0525

(57) ABSTRACT

The disclosure provides a wound battery and a manufacturing method thereof, wherein the wound battery is a wound type easy to produce, and even when a sufficient lamination press pressure and confining pressure are applied, occurrence of cracking, chipping and the like is suppressed and yield is improved, and buckling, short circuits or falling-off of the composite material or the like is suppressed and safety is improved. It is a structure which maintains a flat portion functioning as a battery by pressing and restraining to be in a state as it is, and which does not dispose a composite material in curved portions not functioning as a battery.

### CROSS-REFERENCE TO RELATED APPLICATION

This application claims the priority benefit of Japan Application No. 2018-238120, filed on Dec. 20, 2018. The entirety of the above-mentioned patent application is hereby incorporated by reference herein and made a part of this specification.

### BACKGROUND

### Technical Field

The disclosure relates to a wound battery and a manufacturing method of the wound battery. More specifically, the disclosure relates to a wound battery and a manufacturing method thereof, wherein the wound battery is a wound type easy to produce, has improved yield even when a sufficient lamination press pressure and confining pressure are applied, and has improved safety.

### Description of Related Art

Conventionally, as secondary batteries having high energy density, lithium ion secondary batteries are widely used. A lithium ion secondary battery has a structure in which a separator is present between a positive electrode and a negative electrode and which is filled with a liquid electrolyte (electrolyte solution).

Here, since the electrolyte solution of the lithium ion secondary battery is usually a flammable organic solvent, in particular, safety against heat may be a problem. Therefore, a lithium ion solid battery using an inorganic solid electrolyte in place of the organic liquid electrolyte has been proposed (see Patent Document 1).

The lithium ion solid battery has a structure in which a solid electrolyte layer is disposed between a positive electrode layer and a negative electrode layer. Usually, the positive electrode layer and the negative electrode layer are formed by carrying a composite material including an electrode active material powder and a solid electrolyte powder on a metal foil or the like serving as a current collector.

Here, a lithium ion solid battery is manufactured, for example, by the following method: coating a composite material on both surfaces of a current collector foil to manufacture an electrode sheet; disposing a solid electrolyte on the upper surface of the composite material of the electrode sheet to form a laminate; cutting out the laminate in any shape; producing a positive electrode sheet and a negative electrode sheet of desired size; alternately laminating the positive electrode sheet and the negative electrode sheet; and then performing press molding (see Patent Document 2).

In order to ensure and maintain a desired performance, the solid battery requires press molding at a high contact pressure and a high confining pressure thereafter in a state in which the laminate serving as the battery is formed.

A method similar to a manufacturing method of a lithium ion secondary battery using a conventional electrolyte solution has also been proposed as another manufacturing method of a solid battery. Patent Document 3 proposes a method of making a wound battery by coating a composite material on both surfaces of a current collector foil to manufacture an electrode sheet; disposing a solid electrolyte on the upper surface of the composite material of the electrode sheet to form a laminate; and then stacking and winding the positive electrode sheet and the negative electrode sheet (see Patent Document 3).

A wound solid battery according to the method described in Patent Document 3 is attractive in that it is easy to produce. However, as described above, since the lamination press and the subsequent confining pressure unique to the solid battery are required, cracking, chipping and the like occur in this manufacturing process, and the yield is deteriorated. In addition, there are also concerns about the safety due to buckling, short circuits or falling-off of the composite material or the like.

On the contrary, in the case where the solid battery is manufactured by lowering the lamination press pressure and the confining pressure, the adhesion at the lamination interfaces is lowered, and the battery has poor initial performance. In addition, due to repeated expansion and contraction due to charge and discharge, peeling occurs at the lamination interfaces, which causes the problem of shortening the life cycle of the battery.

### RELATED ART

Patent Document

[Patent Document 1] Japanese Laid-open No. 2000-106154

[Patent Document 2] Japanese Laid-open No. 2015-118870

[Patent Document 3] Japanese Laid-open No. 2011-222288

The disclosure has been made in view of the above-mentioned background, and an object thereof is to provide a wound battery and a manufacturing method thereof, wherein the wound battery is a wound type easy to produce, and even when a sufficient lamination press pressure and confining pressure are applied, occurrence of cracking, chipping and the like is suppressed and yield is improved, and buckling, short circuits or falling-off of the composite material or the like is suppressed and safety is improved.

The inventors have noted that the above problems are caused by the difference of the pressure applied to the curved portions and the flat portion of the wound battery, and the strain stress between the curved portions and the flat portion. Then, it has been found that in the wound battery, the above problems can be solved by a structure which maintains the flat portion functioning as a battery by pressing and restraining to be in a state as it is, and which does not dispose the composite material in the curved portions not functioning as a battery, and the disclosure has been completed.

### SUMMARY

That is, the disclosure provides a wound battery including a positive electrode sheet and a negative electrode sheet, wherein the wound battery is in a flat shape having a curved portion and a flat portion; the positive electrode sheet has: positive composite material coated portions in which a positive composite material is laminated on a positive electrode current collector, and positive composite material uncoated portions in which the positive composite material is not laminated; and the positive composite material uncoated portions are disposed in the curved portion.

In the positive electrode sheet, the positive composite material coated portions and the positive composite material uncoated portions may be alternately formed.

The negative electrode sheet may be a sheet made of a negative electrode active material.

The negative electrode sheet may have: negative composite material coated portions in which a negative composite material is laminated on a negative electrode current collector, and negative composite material uncoated portions in which the negative composite material is not laminated; and in the flat portion, the negative composite material coated portions may be laminated and disposed on the positive composite material coated portions.

The area of the negative composite material coated portions may be greater than or equal to the area of the positive composite material coated portions.

A tab may be connected to the flat portion.

At least one of the positive electrode sheet and the negative electrode sheet may have a solid electrolyte layer on a surface.

At least one of a solid electrolyte sheet and a separator may be disposed between the positive electrode sheet and the negative electrode sheet.

The solid electrolyte sheet may be a sheet made of a solid electrolyte.

An outermost layer of the wound battery may be the solid electrolyte sheet or the separator, and the negative electrode sheet may be disposed on an inner side thereof.

The disclosure further provides a manufacturing method of a wound battery which includes a positive electrode sheet and a negative electrode sheet and is in a flat shape having a curved portion and a flat portion, the manufacturing method including: a positive electrode sheet forming step of alternately forming positive composite material coated portions and positive composite material uncoated portions to form a positive electrode sheet, wherein in the positive composite material coated portions, the positive composite material is laminated by discontinuously coating the positive composite material on the same position of both surfaces of a positive electrode current collector, and in the positive composite material uncoated portions, the positive composite material is not laminated; a center flat portion forming step of overlapping an end portion of the positive electrode sheet and an end portion of the negative electrode sheet to produce a center flat portion serving as a winding starting point; a wound structure forming step of winding the positive electrode sheet and the negative electrode sheet from the center flat portion, so that the positive composite material coated portions are laminated at the same position, to form a wound structure; and a pressing step of pressing the wound structure, so that a lamination portion of the positive composite material coated portions of the wound structure is sandwiched, to form the flat portion.

In the center flat portion forming step, the end portion of the positive electrode sheet or the end portion of the negative electrode sheet may be mountain-folded to form a winding core.

The negative electrode sheet may be a sheet made of a negative electrode active material.

The negative electrode sheet may have: negative composite material coated portions in which a negative composite material is laminated on a negative electrode current collector, and negative composite material uncoated portions in which the negative composite material is not laminated; and in the wound structure forming step, winding may be performed so that the positive composite material coated portions and the negative composite material coated portions may be laminated at the same position.

The area of the negative composite material coated portions may be greater than or equal to the area of the positive composite material coated portions.

At least one of the positive electrode sheet and the negative electrode sheet may have a solid electrolyte layer on a surface.

In the center flat portion forming step, at least one of a solid electrolyte sheet and a separator is disposed between the positive electrode sheet and the negative electrode sheet to produce the center flat portion.

In the wound structure forming step, winding may be performed so that an outermost layer of the wound structure may be the solid electrolyte sheet or the separator.

The solid electrolyte sheet may be a sheet made of a solid electrolyte.

### BRIEF DESCRIPTION OF THE DRAWINGS

FIG. 1 is a cross-sectional view of a wound battery according to an embodiment of the disclosure.

FIG. 2 is a view showing an embodiment of the positive electrode sheet which is a component of the wound battery of the disclosure.

FIG. 3 is a view showing an embodiment of the negative electrode sheet which is a component of the wound battery of the disclosure.

FIG. 4 is a view showing a solid electrolyte sheet which is a component of the wound battery according to an embodiment of the disclosure.

### DESCRIPTION OF THE EMBODIMENTS

The wound battery of the disclosure is a battery which is a wound type easy to produce, has improved yield even when a sufficient lamination press pressure and confining pressure are applied, and has improved safety.

In addition, since lamination press molding with a high load is possible, adhesion of the lamination interfaces is improved, and as a result, energy density and power density of the obtained battery can be improved, and long life can be realized.

Hereinafter, embodiments of the disclosure will be described with reference to the drawings.

<Wound Battery>

A wound battery of the disclosure includes a positive electrode sheet and a negative electrode sheet. The wound battery of the disclosure is in a flat shape having a curved portion and a flat portion; the positive electrode sheet has positive composite material coated portions in which a positive composite material is laminated on a positive electrode current collector, and positive composite material uncoated portions in which the positive composite material is not laminated; and the positive composite material uncoated portions are disposed in the curved portion.

In the disclosure, the “curved portion” refers to a curved portion (R portion) in a structure being in a flat shape formed by winding a laminate obtained by laminating the positive electrode sheet and the negative electrode sheet, and the “flat portion” refers to a portion other than the “curved portion” in the above structure. In the wound battery of the disclosure, a lamination press pressure is applied to the “flat portion.”

The type of the wound battery of the disclosure is not particularly limited. It may be a liquid battery including a liquid electrolyte or a solid battery including a solid or gel electrolyte. Further, in the case where it is a battery including a solid or gel electrolyte, the electrolyte may be organic or inorganic.

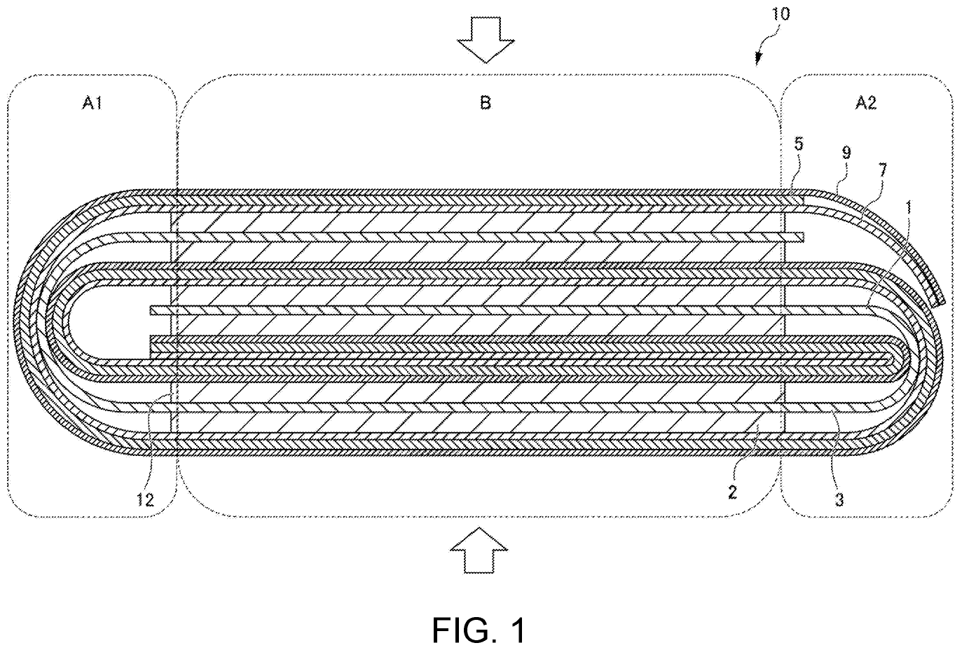

An embodiment of the wound battery of the disclosure is shown in FIG. 1. FIG. 1 is a cross-sectional view of a wound battery 10 of the disclosure. The wound battery 10 according to an embodiment of the disclosure is in a flat shape and has a flat portion B in the center and curved portions A1 and A2 on both sides.

The wound battery 10 shown in FIG. 1 includes a positive electrode sheet 1, a negative electrode sheet 5, a solid electrolyte sheet 7, and a solid electrolyte sheet 9 as its components. The positive electrode sheet 1 has positive composite material coated portions 2 in which positive composite material layers are laminated on a positive electrode current collector, and positive composite material uncoated portions 3 without the positive composite material layers. Then, the solid electrolyte sheet 7 is disposed between the positive composite material coated portions 2 on one surface of the positive electrode sheet 1 and the negative electrode sheet 5, and the solid electrolyte sheet 9 is disposed between the positive composite material coated portions 2 on the other surface of the positive electrode sheet 1 and the negative electrode sheet 5, and these are wound in the longitudinal direction to form the wound battery 10.

In the wound battery 10 shown in FIG. 1, the positive composite material coated portions 2 are disposed only in the flat portion B, and the positive composite material uncoated portions 3 are disposed in the curved portions A1 and A2 which are the end portions of the wound battery 10; therefore, no positive composite material is present in the curved portions A1 and A2.

In addition, the arrows shown in FIG. 1 are the directions of the lamination press applied to the flat portion B of the wound battery 10. In particular, in order to ensure and maintain a desired performance, a solid battery requires press molding at a high contact pressure and a high confining pressure thereafter in a state in which a laminate serving as the battery is formed. In the wound battery 10 shown in FIG. 1, the required pressing is applied from the arrow directions so as to sandwich the flat portion B.

Therefore, in the wound battery 10, a pressure difference is generated between the curved portions A1 and A2 and the flat portion B by the lamination press, and a strain stress is generated. That is, since no pressure is applied to the curved portions A1 and A2, the resistance value thereof is large. However, since the positive composite material is not present in the curved portions A1 and A2, the regions do not function as a battery, and the battery performance is not affected.

The wound battery 10 according to the embodiment shown in FIG. 1 is formed by using two solid electrolyte sheets, the solid electrolyte sheet 7 and the solid electrolyte sheet 9. In addition, in the wound battery 10, it is configured that the outer periphery of the wound battery 10 is covered with the solid electrolyte sheet 9. In addition, the negative electrode sheet 5 is disposed on the inner side of the solid electrolyte sheet 9.

In the case where it is configured that the wound battery of the disclosure has a solid electrolyte sheet like the wound battery shown in FIG. 1, it is preferable that the solid electrolyte sheet is disposed on the outermost layer, and that the negative electrode sheet is disposed on the inner side of the solid electrolyte sheet. With this configuration, the safety of the battery can be improved.

[Positive Electrode Sheet]

The positive electrode sheet, which is a component of the wound battery of the disclosure, is a configuration in which the positive composite material layers are laminated on the positive electrode current collector. In the disclosure, the positive composite material layers are characterized in that they are not formed on the entire surface of the positive electrode current collector but are formed discontinuously. As a result, the positive electrode sheet, which is a component of the wound battery of the disclosure, has the positive composite material coated portions in which the positive composite material is laminated on the positive electrode current collector, and the positive composite material uncoated portions in which the positive composite material is not laminated.

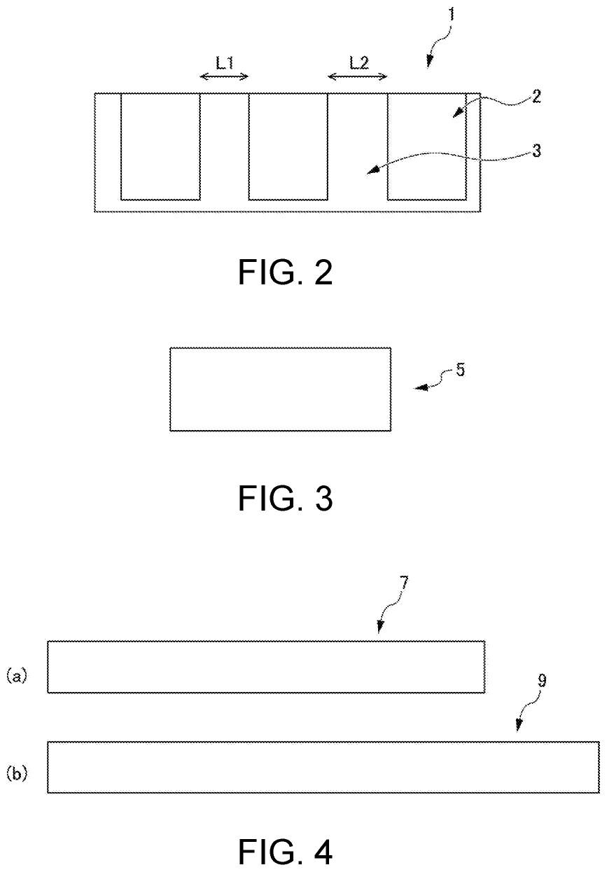

FIG. 2 is a view showing an embodiment of the positive electrode sheet which is a component of the wound battery of the disclosure. As shown in FIG. 2, the positive electrode sheet 1 has the positive composite material coated portions 2 in which the positive composite material is laminated on the positive electrode current collector, and the positive composite material uncoated portions 3 in which the positive composite material is not laminated; and the positive composite material coated portions 2 and the positive composite material uncoated portions 3 are alternately formed.

(Positive Electrode Current Collector)

The positive electrode current collector configuring the positive electrode sheet, which is a component of the wound battery of the disclosure, is not particularly limited, and a positive electrode current collector known as a positive electrode current collector of a lithium ion secondary battery can be applied.

The material of the positive electrode current collector may be, for example, metal materials such as SUS, Ni, Cr, Au, Pt, Al, Fe, Ti, Zn, Cu and the like. Moreover, the shape of the positive electrode current collector may be, for example, a foil shape, a plate shape, a mesh shape, a non-woven fabric shape, a foam shape or the like. Moreover, in order to improve adhesion, carbon and the like may be disposed on the surface of the current collector, and the surface may be roughened. The thickness thereof is not particularly limited either, and can be appropriately selected according to the needs.

(Positive Composite Material)

In the positive electrode sheet of the disclosure, the composite material to be laminated on the positive electrode current collector is not particularly limited as long as it can be used when producing a battery.

The positive composite material contains at least a positive electrode active material, and may further contain a solid electrolyte, a conductive assistant, a binder and the like. The positive electrode active material is not particularly limited as long as it can store and release lithium ions, and may be, for example, LiCoO₂, LiCoO₄, LiMn₂O₄, LiNiO₂, LiFePO₄, lithium sulfide, sulfur or the like.

(Positive Composite Material Coated Portion and Positive Composite Material Uncoated Portion)

In the positive electrode sheet, which is a component of the wound battery of the disclosure, the positive composite material layers are discontinuously formed on the positive electrode current collector. As a result, the positive electrode sheet has the positive composite material coated portions in which the positive composite material is laminated, and the positive composite material uncoated portions in which the positive composite material is not laminated. Then, in the wound battery of the disclosure, winding is performed to form a wound structure so that the positive composite material coated portions are laminated, and thereafter, the flat portion of the wound battery is formed in the lamination portion of the positive composite material coated portions by sandwiching and pressing the lamination portion of the positive composite material coated portions of the wound structure, and the positive composite material uncoated portions are disposed in the curved portions.

Therefore, the wound battery of the disclosure does not have the positive composite material layers in the curved portions. Thereby, even when negative composite material layers are disposed in the curved portions, the curved portions do not exhibit the function of the battery, and, for example, even when the negative composite material peels off, a short circuit can be prevented, and the safety of the battery can be improved. In addition, since a lamination press with a high load can be performed only on the lamination portion of the positive composite material coated portions, the adhesion of the lamination interfaces of the portion functioning as a battery can be improved, and as a result, energy density and power density of the obtained battery can be improved, and long life can be realized.

In the positive electrode sheet according to the embodiment of the disclosure shown in FIG. 2, the positive composite material coated portions 2 and the positive composite material uncoated portions 3 are alternately formed, and L1 and L2 in the figure show the distances between each of the positive composite material coated portions 2. In the case of the positive electrode sheet shown in FIG. 2, when the wound structure is formed by winding, the positive composite material coated portions 2 are laminated at the same position. Thereafter, in the formed wound structure, a portion where the positive composite material coated portions 2 are laminated is sandwiched and pressed to form the flat portion of the wound battery. As a result, the positive composite material uncoated portions 3 are disposed, by every other one, in one of the curved portions (A1 and A2 in FIG. 1) at both ends of the wound battery.

In the positive electrode sheet used in the disclosure, the size of the positive composite material coated portions and the distances between each of the positive composite material coated portions can be appropriately set according to the size and the like of the battery to be configured. For example, when forming a structure by winding, the sizes of the curved portions (A1 and A2 in FIG. 1) serving as both ends of the structure can be different, and in this case, the distances between each of the positive composite material coated portions are different by every other one. That is, by alternately varying the distances L1 and L2 between each of the positive composite material coated portions 2 in FIG. 2, the sizes of the curved portions of the obtained wound battery can be made different on the left and right.

Moreover, the positive electrode sheet used in the disclosure may have a solid electrolyte layer on the surface. The solid electrolyte layer may be disposed so as to cover at least the surface of the positive composite material coated portions. By making the positive electrode sheet have the solid electrolyte layer, it is not necessary to use a solid electrolyte sheet or a separator when producing a battery, and the production process can be simplified.

In the positive electrode sheet, anything capable of lithium ion conduction between the positive electrode and the negative electrode may be used as a solid electrolyte disposed on the positive composite material coated portions, and may be, for example, oxide electrolytes, sulfide electrolytes, inorganic solid electrolytes such as lithium-containing salts, polymer-based solid electrolytes such as polyethylene oxide, gel-based solid electrolytes containing lithium-containing salts or lithium ion conductive ionic liquids, or the like. In addition, the solid electrolyte may include a binder and the like according to the needs.

[Negative Electrode Sheet]

The negative electrode sheet, which is a component of the wound battery of the disclosure, is not particularly limited as long as it has a function of performing current collection of a negative electrode active material layer. A negative electrode active material is not particularly limited as long as it can store and release lithium ions, and may be, for example, metallic lithium, lithium alloys, metal oxides, metal sulfides, metal nitrides, silicon oxides, silicon, carbon materials such as graphite, or the like.

It is preferable that the negative electrode sheet used in the wound battery of the disclosure is a sheet made of the negative electrode active material itself, as shown, for example, in the negative electrode sheet 5 of FIG. 3. In the case of the sheet made of the negative electrode active material, the wound battery of the disclosure can be manufactured by adjusting the disposition only of the positive composite material coated portions when winding the positive electrode sheet and the solid electrolyte sheet or the separator to form the wound structure. At this time, though the negative electrode active material is present in the curved portions of the obtained wound battery, since the positive electrode active material is not present in the curved portions, the curved portions do not exhibit the function as a battery.

Moreover, the negative electrode sheet used in the wound battery of the disclosure may be a configuration in which the negative composite material layers are formed on a negative electrode current collector. In this case, the negative composite material layers may be formed on the entire surface of the negative electrode current collector or may be formed discontinuously as in the case of the positive electrode sheet.

Further, when the negative composite material layers are discontinuously formed on the negative electrode current collector, it is preferable to have negative composite material coated portions in which the negative composite material is laminated, and negative composite material uncoated portions in which the negative composite material is not laminated. Then, when winding the negative electrode sheet together with the positive electrode sheet and the solid electrolyte sheet to form the wound structure, it is desirable to adjust so that the negative composite material coated portions are laminated on the positive composite material coated portions with the solid electrolyte sheet sandwiched therebetween, and that the negative composite material uncoated portions are disposed in the curved portions.

When the negative electrode sheet includes a current collector, the negative electrode current collector is not particularly limited, and a negative electrode current collector known as a negative electrode current collector of a lithium ion secondary battery can be applied. The material of the negative electrode current collector may be, for example, Cu, SUS, Ni, Ti or the like, and the shape of the negative electrode current collector may be, for example, a foil shape, a plate shape, a mesh shape, a non-woven fabric shape, a foam shape or the like. Moreover, in order to improve adhesion, carbon and the like may be disposed on the surface of the current collector, and the surface may be roughened. The thickness of the negative electrode current collector is not particularly limited either, and can be appropriately selected according to the needs.

Further, the negative composite material is not particularly limited as long as it can be used when producing a battery. The negative composite material contains at least the negative electrode active material, and may further contain a solid electrolyte, a conductive assistant, a binder and the like according to the needs.

In addition, in the case of the negative electrode sheet of a configuration in which the negative composite material layers are laminated, it is preferable that the area of the negative composite material coated portions is greater than or equal to the area of the positive composite material coated portions of the positive electrode sheet. When the positive composite material coated portions are smaller than the negative composite material coated portions, by the press after laminating and disposing these to form the wound structure, the positive composite material coated portions are buried in the inner side of the negative composite material coated portions, and cracking may occur at the end portions of the negative composite material coated portions. Moreover, electrocrystallization can be avoided by setting the area of the negative composite material coated portions to be equal to or greater than the area of the positive composite material coated portions of the positive electrode sheet.

Among these, it is preferable that the area of the negative composite material coated portions and the area of the positive composite material coated portions are equal. If the areas are equal, the pressure of the lamination press can be uniformly applied, and the resistance value can be reduced.

Moreover, the negative electrode sheet used in the disclosure may have a solid electrolyte layer on the surface. In the case where the negative electrode sheet has the solid electrolyte layer, the solid electrolyte layer may be disposed so as to cover at least the surface of the negative composite material coated portions. In the case where the negative electrode sheet is a sheet made of the negative electrode active material itself, the solid electrolyte layer may be laminated on the entire negative electrode sheet. By making the negative electrode sheet have the solid electrolyte layer, it is not necessary to use a solid electrolyte sheet or a separator when producing a battery, and the production process can be simplified.

In the case where the negative electrode sheet has the solid electrolyte layer, the solid electrolyte may be the same as or different from the above-described one used in the positive electrode sheet. Anything capable of lithium ion conduction between the positive electrode and the negative electrode may be used, and may be, for example, oxide electrolytes, sulfide electrolytes, inorganic solid electrolytes such as lithium-containing salts, polymer-based solid electrolytes such as polyethylene oxide, gel-based solid electrolytes containing lithium-containing salts or lithium ion conductive ionic liquids, or the like. In addition, the solid electrolyte may include a binder and the like according to the needs.

[Solid Electrolyte Sheet]

In the wound battery of the disclosure, a solid electrolyte sheet may be used as an optional component. In the case where the solid electrolyte sheet is used in the wound battery of the disclosure, the solid electrolyte sheet is disposed between the positive electrode sheet and the negative electrode sheet. In addition, in the case where at least one of the positive electrode sheet and the negative electrode sheet has the solid electrolyte layer as described above, the wound battery of the disclosure can be configured without using the solid electrolyte sheet.

The solid electrolyte sheet used in the disclosure is not particularly limited, and may be, for example, a dense sheet made of an inorganic solid electrolyte and a binder, a composite sheet made by embedding a solid electrolyte in a porous sheet such as a non-woven fabric configured by polypropylene, cellulose, glass and the like, or an organic solid electrolyte sheet, or the like.

Anything capable of lithium ion conduction between the positive electrode and the negative electrode may be used as the solid electrolyte used in the solid electrolyte sheet, and may be, for example, oxide electrolytes, sulfide electrolytes, inorganic solid electrolytes such as lithium-containing salts, polymer-based solid electrolytes such as polyethylene oxide, gel-based solid electrolytes containing lithium-containing salts or lithium ion conductive ionic liquids, or the like. In addition, the solid electrolyte may include a binder and the like according to the needs. The composition ratio of each substance contained in the solid electrolyte is not particularly limited as long as the battery can operate properly.

In the case where the solid electrolyte sheet is used in the wound battery of the disclosure, it may be, for example, an aspect in which at least two solid electrolyte sheets are used, and one solid electrolyte sheet is disposed on one surface of the negative electrode sheet, and the other solid electrolyte sheet is disposed on the other surface of the negative electrode sheet. At this time, the materials of the two solid electrolyte sheets may be the same or different.

Alternatively, for example, it may be an aspect in which one solid electrolyte sheet is used and disposed on the front and back surfaces of one of the negative electrode sheet and the positive electrode sheet.

FIGS. 4(a) and 4(b) show the solid electrolyte sheet 7 and the solid electrolyte sheet 9 which configure the wound battery 10 shown in FIG. 1. In the wound battery 10 shown in FIG. 1, the solid electrolyte sheet 7 is disposed between the positive composite material coated portions 2 of the positive electrode sheet 1 on one surface of the negative electrode sheet 5, and the solid electrolyte sheet 9 is disposed between the positive composite material coated portions 2 of the positive electrode sheet 1 on the other surface of the negative electrode sheet 5. Then, these are wound in the longitudinal direction to form the wound battery 10.

In the case where the wound battery of the disclosure has the solid electrolyte sheet, for the purpose of improving the safety, it is preferable that the outer periphery of the wound battery is covered with the solid electrolyte sheet so that the outermost layer is the solid electrolyte sheet. In addition, it is preferable to dispose the negative electrode sheet on the inner side of the solid electrolyte sheet.

In the wound battery 10 shown in FIG. 1, it is configured that the outer periphery of the wound battery 10 is covered with the solid electrolyte sheet 9. In addition, the negative electrode sheet 5 is disposed on the inner side of the solid electrolyte sheet 9.

[Separator]

In the wound battery of the disclosure, a separator may be used as an optional component. In the case where the wound battery of the disclosure has the separator, the separator is disposed between the positive electrode sheet and the negative electrode sheet. By using a separator, the wound battery of the disclosure can be in an aspect in which a liquid electrolyte is used.

The separator used in the wound battery of the disclosure is not particularly limited as long as it can be impregnated with an electrolyte solution and the like, and a separator known as a separator of a lithium ion secondary battery can be applied. For example, a porous sheet such as a non-woven fabric, a porous film and the like may be used.

The material of the separator is not particularly limited either, and may be, for example, polypropylene, polyethylene, polyethylene terephthalate, polybutylene terephthalate, ethylene-propylene copolymer, cellulose, or the like.

Further, the basis weight and thickness of the separator are not particularly limited either, and may be appropriately set according to the required performance and the like of the wound battery.

[Electrolyte Solution]

In the case where the wound battery of the disclosure is a battery including a liquid electrolyte, an electrolyte solution is used. The electrolyte solution used in the wound battery of the disclosure is not particularly limited, and a known electrolyte solution used in a lithium ion secondary battery can be applied.

For example, ethylene carbonate, dimethyl carbonate, ethyl methyl carbonate, propylene carbonate or the like may be used, or a mixture thereof may be used as a solvent which configures the electrolyte solution. Moreover, for example, lithium-containing salts, such as LiPF₆, LiBF₄, LiClO₄ and the like, or lithium-containing ionic liquids, such as LiTFSi and the like, may be used, or a mixture thereof may be used as an electrolyte which configures the electrolyte solution. In addition, the electrolyte solution may contain an additive and the like according to the needs.

[Other Configurations]

The wound battery of the disclosure may optionally include other configurations for achieving the function as a battery. For example, it is preferable that a positive electrode tab and a negative electrode tab are connected to the flat portion of the wound battery.

Further, the package form of the wound battery of the disclosure is not particularly limited. For example, it may be enclosed in a metal can to form a can cell, or may be enclosed in a laminate sheet of aluminum or the like to form a laminate cell.

<Manufacturing Method of the Wound Battery>

The manufacturing method of the wound battery of the disclosure is not particularly limited, and may be, for example, a method including a positive electrode sheet forming step, a center flat portion forming step, a wound structure forming step, and a pressing step.

[Positive Electrode Sheet Forming Step]

The positive electrode sheet forming step is a step of alternately forming the positive composite material coated portions and the positive composite material uncoated portions, wherein in the positive composite material coated portions, the positive composite material is laminated by discontinuously coating the positive composite material on the same position of both surfaces of the positive electrode current collector, and in the positive composite material uncoated portions, the positive composite material is not laminated.

A method of discontinuously coating the positive composite material is not particularly limited. For example, it may be a method of forming a positive composite material containing a positive electrode active material, coating the positive composite material on a positive electrode current collector by discontinuous coating, and then performing drying and rolling.

Further, in the disclosure, in the positive electrode sheet forming step, the solid electrolyte layer may be formed at least on the positive composite material coated portions. The forming method of the solid electrolyte layer is not particularly limited, and a known method can be applied.

[Center Flat Portion Forming Step]

The center flat portion forming step is a step of overlapping an end portion of the positive electrode sheet obtained in the positive electrode sheet forming step and an end portion of the negative electrode sheet to produce a center flat portion serving as a winding starting point.

At least one of the solid electrolyte sheet and the separator may be disposed between the positive electrode sheet and the negative electrode sheet according to the needs.

In the center flat portion forming step, the end portion of the positive electrode sheet or the end portion of the negative electrode sheet may be mountain-folded to form a winding core. By forming the winding core, winding can be performed with the winding core as the axis.

Further, in the case where the winding core is formed, the center flat portion may be in an aspect where the negative electrode sheet is overlapped on the mountain-folded positive electrode sheet, an aspect where the positive electrode sheet is overlapped on the mountain-folded negative electrode sheet, or an aspect where the mountain-folded positive electrode sheet and the mountain-folded negative electrode sheet are overlapped. One of the solid electrolyte sheet and the separator may be disposed on the inner side (center) of the mountain-folded winding core.

In the wound battery 10 according to the embodiment of the disclosure shown in FIG. 1, in the center flat portion forming step, the solid electrolyte sheet 7 is disposed on one surface of the negative electrode sheet 5, and the solid electrolyte sheet 9 is disposed on the other surface, and thereafter, the end portion is mountain-folded to form the winding core, and the positive electrode sheet 1 is overlapped on the outer side of the solid electrolyte sheet 9 to produce the center flat portion.

In the disclosure, the negative electrode sheet may be configured by the sheet made of the negative electrode active material itself, or may be configured by the negative composite material layers formed on the negative electrode current collector. In the case where it is configured by the negative composite material layers formed on the negative electrode current collector, it is preferable that the area of the negative composite material coated portions is greater than or equal to the area of the positive composite material coated portions.

Moreover, in the disclosure, a negative electrode sheet having a solid electrolyte layer on the surface may be used as the negative electrode sheet. In the case where the negative electrode sheet has the solid electrolyte layer, the solid electrolyte layer may be disposed so as to cover at least the surface of the negative composite material coated portions. In the case where the negative electrode sheet is the sheet made of the negative electrode active material itself, the solid electrolyte layer may be laminated on the entire negative electrode sheet. The forming method of the solid electrolyte layer is not particularly limited, and a known method can be applied.

[Wound Structure Forming Step]

The wound structure forming step is a step of winding the positive electrode sheet and the negative electrode sheet with the center flat portion produced in the center flat portion forming step as the starting point, so that the positive composite material coated portions are laminated at the same position, to form the wound structure. Further, in the wound structure forming step, according to the needs, winding may be performed in a state where at least one of the solid electrolyte sheet and the separator is disposed between the positive electrode sheet and the negative electrode sheet.

In the case of using the sheet configured by the negative composite material layers formed on the negative electrode current collector as the negative electrode sheet, in the wound structure forming step, it is preferable to adjust so that the negative composite material coated portions are laminated and disposed on the positive composite material coated portions to form the wound structure.

Further, in the disclosure, for the purpose of improving the safety, it is desirable that the outermost layer of the battery is the solid electrolyte sheet or the separator. For this, it is preferable to perform winding with use of the solid electrolyte sheet or the separator having a sufficient length, and to produce the wound structure covered by the end portion of the solid electrolyte sheet or the separator.

The wound battery 10 shown in FIG. 1 uses the solid electrolyte sheet 9 and the solid electrolyte sheet 7 with substantially the same length, and in the wound structure forming step, winding is performed so that the solid electrolyte sheet 9 covers the outer periphery of the wound battery 10. In this way, the negative electrode sheet 5 is disposed on the inner side of the solid electrolyte sheet 9.

[Pressing Step]

The pressing step is a step of pressing the wound structure, so that the lamination portion of the positive composite material coated portions of the wound structure obtained in the wound structure forming step is sandwiched, to form the flat portion. The curved portions are formed simultaneously with the formation of the flat portion.

The arrows shown in FIG. 1 indicate the directions in which the wound structure is pressed. In the embodiment shown in FIG. 1, the flat portion B and the curved portions A1 and A2 are produced by applying pressure to the wound structure, with the region where the positive composite material coated portions 2 are laminated being sandwiched, to produce the wound battery 10.

### DESCRIPTION OF REFERENCE NUMERALS

1: Positive electrode sheet
2: Positive composite material coated portion
3: Positive composite material uncoated portion
5: Negative electrode sheet
7, 9: Solid electrolyte sheet
10: Wound battery
A1, A2: Curved portion
B: Flat portion
L1, L2: Distance between positive composite material coated portions

What is claimed is:

1. A wound battery comprising a positive electrode sheet and a negative electrode sheet, wherein
the wound battery is in a flat shape having a curved portion and a flat portion,
the positive electrode sheet has:
positive composite material coated portions in which a positive composite material is laminated on a positive electrode current collector; and
positive composite material uncoated portions in which the positive composite material is not laminated, and
the positive composite material uncoated portions are disposed in the curved portion.

2. The wound battery according to claim 1, wherein in the positive electrode sheet, the positive composite material coated portions and the positive composite material uncoated portions are alternately formed.

3. The wound battery according to claim 1, wherein the negative electrode sheet is a sheet comprising a negative electrode active material.

4. The wound battery according to claim 1, wherein
the negative electrode sheet has:
negative composite material coated portions in which a negative composite material is laminated on a negative electrode current collector; and
negative composite material uncoated portions in which the negative composite material is not laminated, and
in the flat portion, the negative composite material coated portions are laminated and disposed on the positive composite material coated portions.

5. The wound battery according to claim 4, wherein the area of the negative composite material coated portions is greater than or equal to the area of the positive composite material coated portions.

6. The wound battery according to claim 1, wherein a tab is connected to the flat portion.

7. The wound battery according to claim 1, wherein at least one of the positive electrode sheet and the negative electrode sheet has a solid electrolyte layer on a surface.

8. The wound battery according to claim 1, wherein at least one of a solid electrolyte sheet and a separator is disposed between the positive electrode sheet and the negative electrode sheet.

9. The wound battery according to claim 8, wherein an outermost layer of the wound battery is the solid electrolyte sheet or the separator, and the negative electrode sheet is disposed on an inner side of the solid electrolyte sheet or the separator.

10. The wound battery according to claim 8, wherein the solid electrolyte sheet is a sheet comprising a solid electrolyte.

11. A manufacturing method of a wound battery which comprises a positive electrode sheet and a negative electrode sheet and is in a flat shape having a curved portion and a flat portion, the manufacturing method comprising:
a positive electrode sheet forming step of alternately forming positive composite material coated portions and positive composite material uncoated portions to form a positive electrode sheet, wherein in the positive composite material coated portions, a positive composite material is laminated by discontinuously coating the positive composite material on the same position of both surfaces of a positive electrode current collector, and in the positive composite material uncoated portions, the positive composite material is not laminated;
a center flat portion forming step of overlapping an end portion of the positive electrode sheet and an end portion of the negative electrode sheet to produce a center flat portion serving as a winding starting point;
a wound structure forming step of winding the positive electrode sheet and the negative electrode sheet from the center flat portion, so that the positive composite material coated portions are laminated at the same position, to form a wound structure; and
a pressing step of pressing the wound structure, so that a lamination portion of the positive composite material coated portions of the wound structure is sandwiched, to form the flat portion.

12. The manufacturing method of the wound battery according to claim 11, wherein in the center flat portion forming step, the end portion of the positive electrode sheet or the end portion of the negative electrode sheet is mountain-folded to form a winding core.

13. The manufacturing method of the wound battery according to claim 11, wherein the negative electrode sheet is a sheet comprising a negative electrode active material.

14. The manufacturing method of the wound battery according to claim 11, wherein
the negative electrode sheet has:
negative composite material coated portions in which a negative composite material is laminated on a negative electrode current collector; and
negative composite material uncoated portions in which the negative composite material is not laminated, and
in the wound structure forming step, winding is performed so that the positive composite material coated portions and the negative composite material coated portions are laminated at the same position.

15. The manufacturing method of the wound battery according to claim 14, wherein the area of the negative composite material coated portions is greater than or equal to the area of the positive composite material coated portions.

16. The manufacturing method of the wound battery according to claim 11, wherein at least one of the positive electrode sheet and the negative electrode sheet has a solid electrolyte layer on a surface.

17. The manufacturing method of the wound battery according to claim 11, wherein in the center flat portion forming step, at least one of a solid electrolyte sheet and a separator is disposed between the positive electrode sheet and the negative electrode sheet to produce the center flat portion.

18. The manufacturing method of the wound battery according to claim 17, wherein in the wound structure forming step, winding is performed so that an outermost layer of the wound structure is the solid electrolyte sheet or the separator.

19. The manufacturing method of the wound battery according to claim 17, wherein the solid electrolyte sheet is a sheet comprising a solid electrolyte.
